(19) United States
(12) Patent Application Publication
(10) Pub. No.: US 2016/0248266 A1
(43) Pub. Date: Aug. 25, 2016

(54) Heterogeneous Battery Cell Charging

(71) Applicant: Microsoft Technology Licensing, LLC, Redmond, WA (US)

(72) Inventors: Anthony John Ferrese, Berkeley, CA (US); Pan Hu, Amherst, MA (US); Stephen E. Hodges, Cambridge (GB); Ranveer Chandra, Bellevue, WA (US); Julia L. Meinershagen, Seattle, WA (US); Nissanka Arachchige Bodhi Priyantha, Redmond, WA (US); Anirudh Badam, Redmond, WA (US); Thomas Moscibroda, Beijing (CN); Jon Dutra, Redmond, WA (US)

(21) Appl. No.: 14/626,600

(22) Filed: Feb. 19, 2015

(51) Int. Cl. H02J 7/00

(52) U.S. Cl. CPC H02J 7/0003; H02J 7/007; H02J 7/0021

(57) ABSTRACT

Heterogeneous battery cell charging techniques are described for a device having a battery system with heterogeneous battery cells. A control system is provided that is configured to determine a charging strategy for charging the heterogeneous battery cells based upon an analysis of a plurality of contextual factors. For example, contextual factors may indicate anticipated future load conditions, battery usage preferences established for the battery system, and/or other factors indicative of an overall context in which charging occurs. Different charging strategies that indicate which battery cells to charge and the way in which charging is to be conducted may be mapped to different combinations of the contextual factors such that the charging is dynamically tailored to different contexts. A selected charging strategy is then employed to distribute charging current from a power source among the heterogeneous battery cells in the manner designated by the selected charging strategy.

### BACKGROUND

Mobile computing devices have been developed to increase the functionality that is made available to users in a mobile setting. For example, a user may interact with a mobile phone, tablet computer, or other mobile computing device to check email, surf the web, compose texts, interact with applications, and so on. One challenge that faces developers of mobile computing devices is efficient power management and extension of battery life. For example, extended processing of tasks by processors at or near capacity may drain the device battery and create thermal conditions that may force shutdown of the device. Various power management strategies may be applied to control processor and battery utilization generally at the expense of overall device performance. If power management implemented for a device fails to strike a good balance between performance and battery life, user dissatisfaction with the device and manufacturer may result.

### SUMMARY

Heterogeneous battery cell charging techniques are described for a device having a battery system with heterogeneous battery cells. A control system is provided that is configured to determine a charging strategy for charging the heterogeneous battery cells based upon an analysis of a plurality of contextual factors. For example, contextual factors may indicate anticipated future load conditions, battery usage preferences established for the battery system, and/or other factors indicative of an overall context in which charging occurs. Different charging strategies that indicate which battery cells to charge and the way in which charging is to be conducted may be mapped to different combinations of the contextual factors such that the charging is dynamically tailored to different contexts. A selected charging strategy is then employed to distribute charging current from a power source among the heterogeneous battery cells in the manner designated by the selected charging strategy.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an example operating environment in accordance with one or more implementations.

FIG. 2 is diagram depicting example details of a computing device having a battery system with heterogeneous battery cells in accordance with one or more implementations.

FIG. 3 is diagram depicting example a charging architecture for a battery system in accordance with one or more implementations.

FIG. 4 is a flow diagram that describes details of an example procedure for charging of heterogeneous battery cells in accordance with one or more implementations.

FIG. 5 is a flow diagram that describes details of an example procedure for distributing charging current to cells of a battery system in accordance with one or more implementations.

FIG. 6 is a block diagram of a system that can be employed for heterogeneous cell charging in accordance with one or more implementations.

### DETAILED DESCRIPTION

Overview

Traditionally, mobile devices employed battery systems having a single cell or a collection of homogeneous cells connected in a symmetric manner. For such systems, charge controllers generally treat cells collectively as a single unit or a group of batteries having the same characteristics and provide constant power for charging (e.g., constant current or constant voltage) based on performance of the battery system as a whole. Accordingly, existing charge controllers fail to address charging on a per-cell basis and may be inadequate for charging of battery systems having heterogeneous battery cells.

Heterogeneous battery cell charging techniques are described for a device having a battery system with heterogeneous battery cells. A control system is provided that is configured to determine a charging strategy for charging the heterogeneous battery cells based upon an analysis of a plurality of contextual factors. For example, contextual factors may indicate anticipated future load conditions, charging opportunities, battery usage preferences established for the battery system, and/or other factors indicative of an overall context in which charging occurs. Different charging strategies that indicate which battery cells to charge and the way in which charging is to be conducted may be mapped to different combinations of the contextual factors such that the charging is dynamically tailored to different contexts. A selected charging strategy is then employed to distribute charging current from a power source among the heterogeneous battery cells in the manner designated by the selected charging strategy.

Heterogeneous battery cell charging techniques provide an intelligent control system for charging of a diverse set of heterogeneous battery cells. A charge controller as described in this document is adapted to implement charging policies that account for a variety of contextual factors from more sources than a traditional charge controller, including but not limited to the level of charging current available, the state of charge of each of the cells, differences in cell-specific characteristics such as capacity and chemistry, current and anticipated operating conditions, user preferences, application requests, and so forth. Thus, different charging policies may be applied in different circumstances. Individual cells (or groups of cells) may be connected directly to the charge controller, which enables charging control on a per-cell basis via respective paths used to route power to and from the cells. In addition to selectively distributing charging current among cells, a charge controller configured in the manner described herein can also orchestrate power exchange between battery cells to move charge from one cell to another. This enables re-balancing of load between cells of different capacities, ages and chemistries in some usage scenarios. Charging performed in this manner enables more efficient charging of a plurality of cells on an individual basis which tailors charging to different contexts, increases device performance, and extends battery life.

In the discussion that follows, a section titled “Operating Environment” is provided and describes one example environment in which one or more implementations can be employed. Following this, a section titled “Heterogeneous Battery Cell Charging Details” describes example details and procedures in accordance with one or more implementations. Last, a section titled “Example System” describes example computing systems, components, and devices that can be utilized for one or more implementations of heterogeneous battery cell charging.

Operating Environment

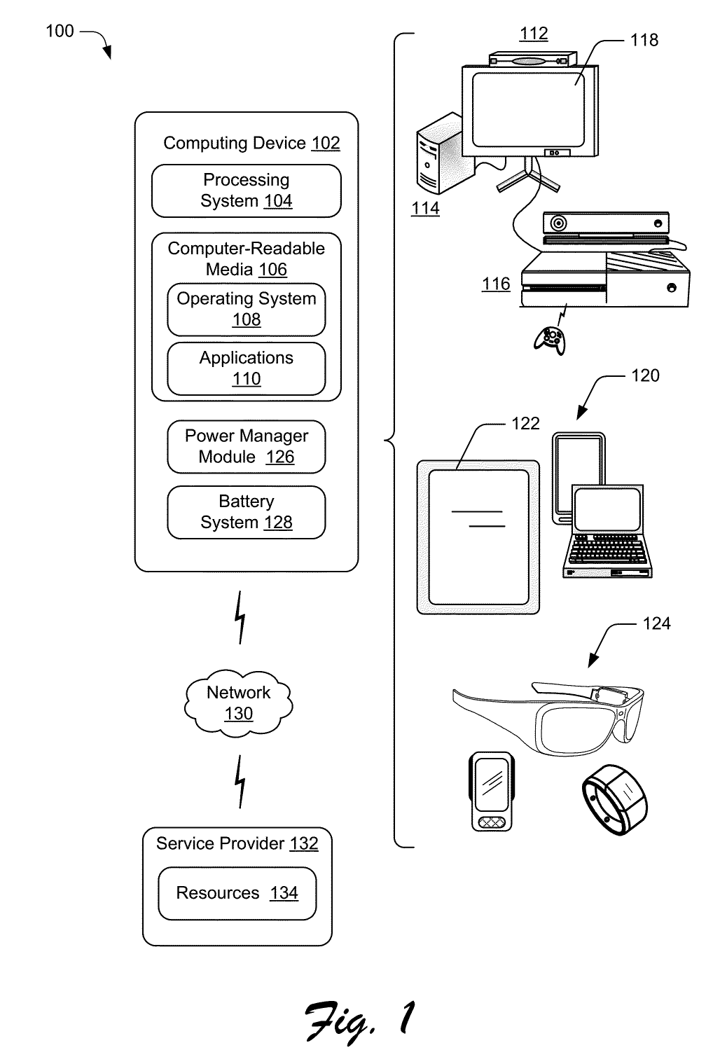

FIG. 1 illustrates an operating environment in accordance with one or more embodiments, generally at 100. The environment 100 includes a computing device 102 having a processing system 104 with one or more processors and devices (e.g., CPUs, GPUs, microcontrollers, hardware elements, fixed logic devices, etc.), one or more computer-readable media 106, an operating system 108, and one or more applications 110 that reside on the computer-readable media and which are executable by the processing system. The processing system 104 may be configured to include multiple independent processors configured in parallel or in series and one or more multi-core processing units. A multi-core processing unit may have two or more processors (“cores”) included on the same chip or integrated circuit. In one or more implementations, the processing system 104 may include multiple processing cores that provide a range of performance capabilities, processing efficiencies, and power usage characteristics.

The processing system 104 may retrieve and execute computer-program instructions from applications 110 to provide a wide range of functionality to the computing device 102, including but not limited to gaming, office productivity, email, media management, printing, networking, web-browsing, and so forth. A variety of data and program files related to the applications 110 can also be included, examples of which include games files, office documents, multimedia files, emails, data files, web pages, user profile and/or preference data, and so forth.

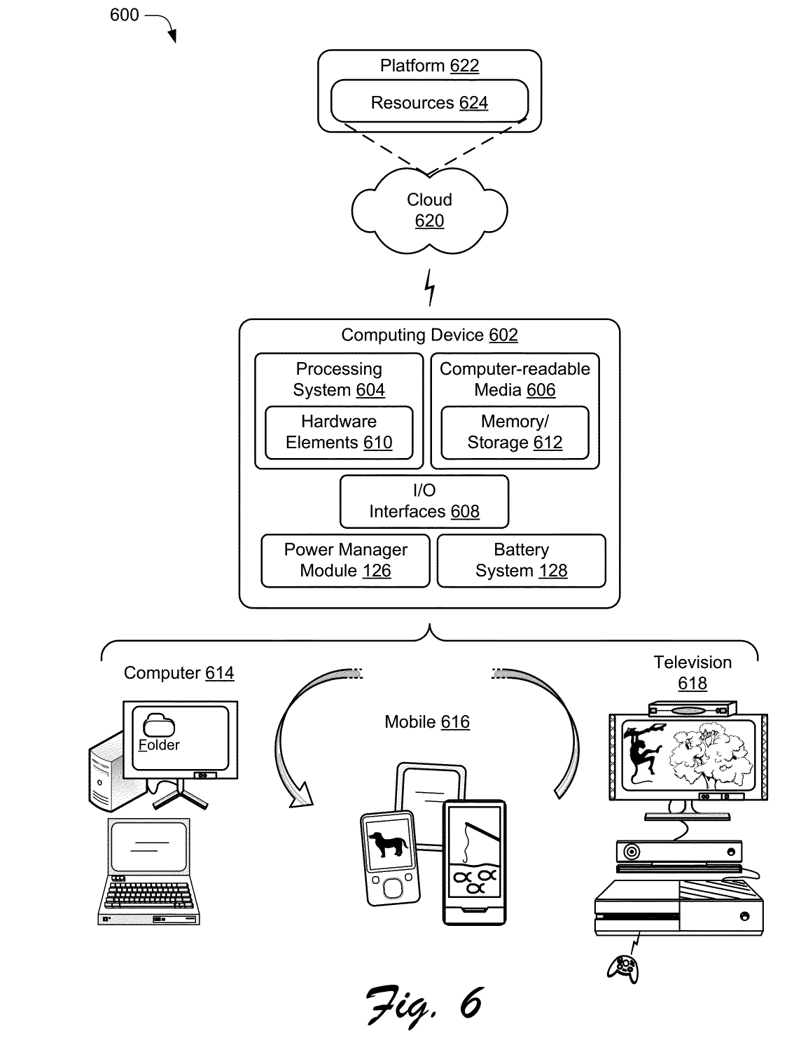

The computing device 102 can be embodied as any suitable computing system and/or device such as, by way of example and not limitation, a gaming system, a desktop computer, a portable computer, a tablet or slate computer, a handheld computer such as a personal digital assistant (PDA), a cell phone, a set-top box, a wearable device (e.g., watch, band, glasses, etc.), and the like. For example, as shown in FIG. 1 the computing device 102 can be implemented as a television client device 112, a computer 114, and/or a gaming system 116 that is connected to a display device 118 to display media content. Alternatively, the computing device may be any type of portable computer, mobile phone, or portable device 120 that includes an integrated display 122. A computing device may also be configured as a wearable device 124 that is designed to be worn by, attached to, carried by, or otherwise transported by a user. Examples of wearable devices 124 depicted in FIG. 1 include glasses, a smart band or watch, and a pod device such as clip-on fitness device, media player, or tracker. Other examples of wearable devices 124 include but are not limited to badges, a key fob, an access card, and a ring, an article of clothing, a glove, or a bracelet, to name a few examples. Further the computing device 102 may represent an on-board computer of a vehicle, such as an electric car that has a chargeable battery system. Any of the computing devices can be implemented with various components, such as one or more processors and memory devices, as well as with any combination of differing components. One example of a computing system that can represent various systems and/or devices including the computing device 102 is shown and described below in relation to FIG. 6.

The computer-readable media can include, by way of example and not limitation, all forms of volatile and non-volatile memory and/or storage media that are typically associated with a computing device. Such media can include ROM, RAM, flash memory, hard disk, removable media and the like. Computer-readable media can include both “computer-readable storage media” and “communication media,” examples of which can be found in the discussion of the example computing system of FIG. 6.

The computing device 102 may also include a power manager module 126 and a battery system 128 that operate as described above and below. The battery system 128 is configured to include multiple heterogeneous battery cells as discussed in greater detail below. The power manager module 126 and battery system 128 may be provided using any suitable combination of hardware, software, firmware, and/or logic devices. As illustrated, the power manager module 126 and battery system 128 may be configured as separate, standalone modules. In addition or alternatively, the power manager module 126 may also be configured as a module that is combined with the operating system 108 or implemented via a controller or other component of the battery system 128.

The power manager module 126 represents functionality operable to assess system-wide power management considerations and manage the availability heterogeneous cells of the battery system 128, processors, and/or processing cores based on the assessment. In one or more implementations, the power manager module 126 may be configured to implement charging policies established based on power management considerations to control the battery system 128. This may involve analyzing contextual factors including but not limited to usage preferences or requests from users or applications, battery characteristics, battery charge levels/states, device power state, actual and anticipated workloads, power source characteristics, time available for charging, thermal conditions, user presence, processor/core utilization, application context, device context, priority, and other contextual clues that may be used to drive power management decisions at the system level. The power manager module 126 may be configured to apply different charging policies that are mapped to different combinations of the contextual factors such that charging is dynamically tailored to different contexts in which charging occurs. Applying a charging policy may involve communicating control signals or directives to direct operation of a charge controller to implement a particular charging policy that is selected based on analysis of the contextual factors. Details regarding these and other aspects of heterogeneous battery cell charging are discussed in the following section.

The environment 100 further depicts that the computing device 102 may be communicatively coupled via a network 130 to a service provider 132, which enables the computing device 102 to access and interact with various resources 134 made available by the service provider 132. The resources 134 can include any suitable combination of content and/or services typically made available over a network by one or more service providers. For instance, content can include various combinations of text, video, ads, audio, multi-media streams, applications, animations, images, webpages, and the like. Some examples of services include, but are not limited to, an online computing service (e.g., “cloud” computing), an authentication service, web-based applications, a file storage and collaboration service, a search service, messaging services such as email and/or instant messaging, and a social networking service.

Having described an example operating environment, consider now example details and techniques associated with one or more implementations of heterogeneous battery cell charging.

Heterogeneous Battery Cell Charging Details

To further illustrate, consider the discussion in this section of example devices, components, procedures, and implementation details that may be utilized to provide heterogeneous battery cell charging as described herein. In general, functionality, features, and concepts described in relation to the examples above and below may be employed in the context of the example procedures described in this section. Further, functionality, features, and concepts described in relation to different figures and examples in this document may be interchanged among one another and are not limited to implementation in the context of a particular figure or procedure. Moreover, blocks associated with different representative procedures and corresponding figures herein may be applied together and/or combined in different ways. Thus, individual functionality, features, and concepts described in relation to different example environments, devices, components, figures, and procedures herein may be used in any suitable combinations and are not limited to the particular combinations represented by the enumerated examples in this description.

Example Device

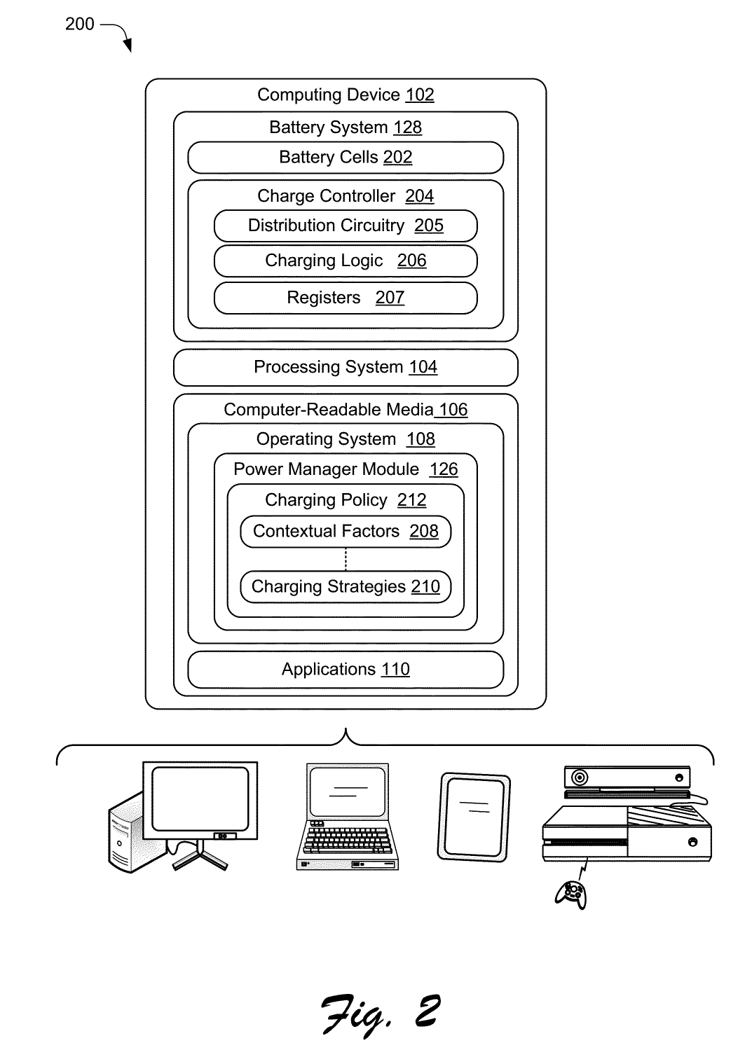

FIG. 2 depicts generally at 200 example details of a computing device 102 having a battery system 128 with heterogeneous battery cells in accordance with one or more implementations. Computing device 102 also includes processing system 104, computer readable media 106, operating system 108 and applications 110 as discussed in relation to FIG. 1. In the depicted example, a power manager module 126 is also shown as being implemented as a component of the operating system 108.

By way of example and not limitation, the battery system 128 is depicted as having battery cells 202 and a charge controller 204. The battery cells 202 are representative of various different kinds of cells that may be included with the computing device. As mentioned, battery cells 202 includes cells having different characteristics such as different sizes/capacities, chemistries, battery technologies, shapes, state of charge (SOC), charge rates, discharge rates and so forth. Accordingly, the battery system 128 includes a diverse combination of multiple battery cells at least some of which have different characteristics one to another. Various combinations of battery cells 202 may be utilized to provide a range of capacities, performance capabilities, efficiencies, and power usage characteristics that may be mapped to different end usage scenarios.

The charge controller 204 is representative of a portion of a control system to control charging of the battery cells 202 in a variety of ways. The charge controller 204 may be configured using various logic, hardware, circuitry, firmware, and/or software suitable to connect the battery cells 202 one to another, supply power for charging of the cells, switch paths established between the battery cells, and so forth. The charge controller 204 may be implemented as a standalone module of the battery system 128 as illustrated that is designed to provide various functionality related to management of charge levels of the battery cells 202. Alternatively, the charge controller 204 may be implemented via a combined battery controller (not shown) for the system designed to manage operation of the battery system 128 as whole including both charging of the battery cells and delivery of power from the battery cells to service a system load.

By way of example and not limitation, the charge controller 204 in FIG. 2 is depicted as including distribution circuitry 205, charging logic 206, and registers 207 operable to implement charging on a per-cell basis for a battery system having heterogeneous battery cells. In particular, the distribution circuitry 206 represents circuit lines, switches, electronic devices, and/or other hardware components provided to interconnect the heterogeneous battery cells and route charging current from a power source to heterogeneous battery cells. In one or more implementations, the distribution circuitry 205 is configured to connect each of the heterogeneous battery cells directly to the charge controller to provide individual current paths to and from each of the heterogeneous battery cells. In other words, distribution circuitry 205 provides switching mechanisms to route the charging current via the individual current paths and control charge distribution to the cells.

The charging logic 206 represents fixed logic circuity, firmware, and/or other hardware based logic of the controller that may be configured to control the distribution circuitry 206 for charging. The charging logic 206 may include functionality for both distribution of charging current to the heterogeneous battery cells and migration of charge between cells of the heterogeneous battery cells. The charging logic 206 may reference parameter values reflected by registers 207 to operate the distribution circuitry 205 in a manner that is implements a corresponding charging strategy. As described in greater detail below, a charging strategy may be established dynamically at runtime based on a combination of contextual factors.

In particular, registers 207 represent components of the charge controller 204 that are configurable to specify parameters that are employed by charging logic to implement a charging strategy established for the battery system. Changing of the registers provides a mechanism to change the charging strategy applied by the charge controller. In particular, the registers hold values that reflect charging constraints for the cells in accordance with the charging strategy. The registers 207 may be made accessible to developers, users, and/or application to dynamically program the charge controller to implement different charging strategies by setting the parameters associated with the registers to corresponding values. By way of example and not limitation, an operating system 108 of the computing device 102 having the charge controller may expose an application programming interface (API) through which the registers may be accessed, set, and updated in dependence upon contextual factors. The registers 207 may include registers associated with each battery cell to specify charging constraints on a per-cell basis, such as which of the cells are active and inactive for charging, portions of charging current to direct to each cell during charging, priority of cells to control charging order of the cells, or levels of charge to attain for each cell during charging, to name a few examples.

Thus, rather than merely interconnecting batteries in parallel or series and charging the cells in a collective manner, the charge controller can be utilized to set-up a charging scheme to charge different battery cells in different ways under different circumstances. The distribution circuitry 204 may be employed to connect to individual cells or groups of cells, prioritize charging of the battery cells, deliver different amounts of charging current to different cells, charge cells to different specified levels, migrate charge between cells, and so forth.

In one approach, charging of battery cells occurs under the influence of the power manager module 126. In particular, charging is dependent upon analysis of a plurality of contextual factors 208 that are employed to select from among multiple different charging strategies 210. In one approach, different combinations of contextual factors 208 or “charging contexts” are mapped to or otherwise associated with different charging strategies 210 to create a charging policy 212 that is enforced via the power manager module 126. Recognition of a particular charging context based upon analysis of the contextual factors 208 enables the power manager module 126 to choose an appropriate charging strategy defined by the charging policy 212 and direct the charge controller 204 to implement the strategy. The power manager module 126 may be configured to provide a charging policy 212 that matches a number of pre-defined charging contexts to corresponding strategies. In addition or alternatively, the power manager module 126 may provide functionality to facilitate management of the charging policy 212. For example, the power manager module 126 may provide a dialog, interface or other suitable instrumentality to enable access to the charging policy 212, modifications to pre-defined context or strategy, creation of custom contexts and strategies, designation of preferences for charging and using cells, and so forth.

The power manager module 126 may be configured to collect and analyze a variety of different contextual factors 208 from multiple different sources to make power management decisions including decisions regarding which charging strategies to apply in different circumstances. For example, contextual factors 208 may include information regarding batteries of the battery system 128 such as the types of battery cells 202, characteristics of the cells, charge states, charging rates, battery cell ages and aging constraints, and so forth. Contextual factors 208 also including information regarding current operating conditions that reflects factors including the device power state, actual workloads, thermal conditions, battery cell temperatures, user presence, processor/core utilization, application context, and other factors indicative of current operating conditions. Additional contextual factors 208 relate to characteristics of power employed for charging such as the amount of power (current and/or voltage), time available for charging, and the type of power source used (e.g., free or paid, green source or not, OEM or third-party charger, etc.). Further, contextual factors 208 include application and user preferences for charging that may be designated by the charging policy 212 as well as specific requests or directives from applications and users.

Additionally, power manager module 126 may also utilize contextual factors 208 to glean information regarding anticipated future operating conditions to inform decisions regarding which charging strategies to apply. For example, the power manager module 126 may be able to access and analyze past user activity, location data, daily behavior patterns, application usage statistics, and schedule information available from the OS and/or other applications to make predictions regarding future operating conditions. This enable the power manager module 126 to anticipate when, where, and how the device is likely to be used and thereby predict future load conditions. Additionally, the analysis informs the power manager module 126 regarding typical locations and charging opportunities that are available, time available for charging, time between charging opportunities, and behavior of the user with respect to charging.

Combinations of one or more of the different contextual factors 208 may be relied upon to select an appropriate charging strategy 210 that is tailored to the situation. In general, the charging strategies 210 specify charging constraints for charging of the battery cells 202 on a per-cell basis. given a context that is recognized based on contextual factors 208, a corresponding a charging policy is configured to specify cells that are active and inactive for charging, portions of available charging current to direct to each cell during charging, priority of cells to control charging order of the cells, levels of charge to attain for each cell during charging, time to charge each cell, charging rates, and other charging constraints. For example, a policy may be designed to maximize charge absorbed at low battery cell temperatures to avoid undesirable thermal conditions. In another example, a policy is developed in consideration of battery ages and aging constraints to strike balance between overall charging rates and battery longevity.

Different charging strategies 210 are used to control charging in a manner that can balance charging fast and charging efficiently (e.g., getting the most charge) in dependence upon the situation. Additionally, the charging is tailored to current and future operating conditions as well as charging preferences. For instance, during night time hours, the system may recognize that device activity will be low and a relatively long period of time will be available for charging. In this situation, an efficient charging strategy may be implemented to charge all of the cells as fully as possible. On the other hand, when the system recognizes that battery levels are low and time available for charging is likely to be low (e.g., schedule indicates an upcoming meeting at a remote location), the charging strategy applied may be configured to implement fast charging and may also selectively prioritize charging of types of cells that are well-suited to fast charging. In another example, the system may recognize based on current and anticipated workloads that a large amount of background tasks are likely to occur in an upcoming period of time, but available charge is primarily maintained within high performance cells that are better suited for other kinds of tasks. In this case, the charging strategy may be implemented to cause migration of charge from the high performance cells to power-efficient cells that can handle the background tasks. A variety of other examples are also contemplated.

Example Charging Architecture

Generally speaking, a battery system 128 having multiple diverse battery cells may be configured in various ways and employ a variety of different types of batteries. In one or more implementations, different battery cells 202 included with a system have different characteristics, such as differences in one or more of battery chemistry, capacity, voltage, size, shapes and/or state of charge (SOC), to name a few examples. Using different types of cells provide flexibility for design of the battery system and circuit boards, and consequently enables device developers to make better utilization of internal space to provide devices having increased battery life and efficiency. The different battery cells may be arranged in a circuit that enables selective switching among the battery cells. Additionally, a charging controller 204 is configured to enable charging of cells on a per-cell basis as described herein.

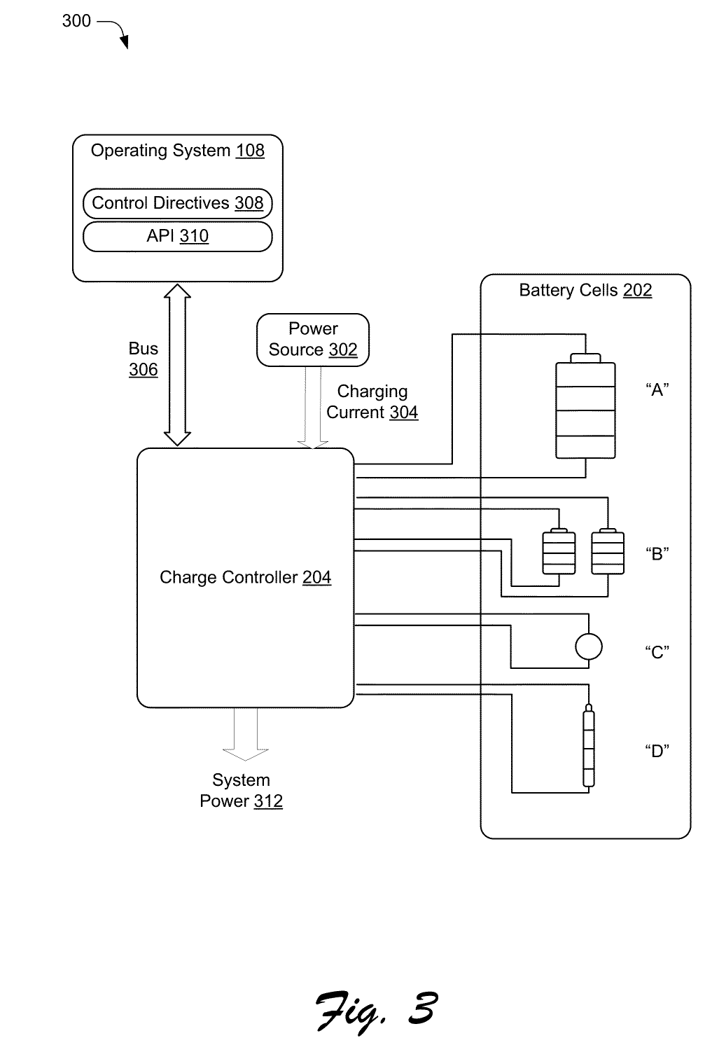

In particular, FIG. 3 depicts generally at 300 an illustrative example charging architecture for a battery system having multiple battery cells 202. The battery cells 202 may be connected in a circuit that includes a charge controller 204 as described in relation to the example of FIG. 2. In the depicted example, battery cells 202 include different representative cell groups labeled “A”, “B”, “C”, and “D” each of which may include one or more individual cells. Each of the cell groups is connected directly to the charge controller 204 in a manner that provides individual current paths to and from each of the battery cells/groups for charging and/or discharge. The depicted battery cells 202 are also represented as a collection of heterogeneous battery cells for a battery system that have different characteristics as noted previously such as different sizes, shapes, state of charge (SOC), capacities, chemistry, and so forth.

The charge controller 204 is depicted as being connected to a power source 302 from which charging current 304 may be obtained to charge the battery cells 202. To perform the charging, the charge controller 204 may implement a charging strategy 210 that is selected based on contextual factors 208 as previously discussed. When power is supplied via the power source 302, distribution circuitry 205 of the charge controller 204 can direct the current to cells or groups cells using the individual current paths (e.g., on a per-cell or per-group basis).

As further represented in FIG. 3, the charge controller 204 may be configured to coordinate charging activity with an operating system 108 via communications exchanged via a bus 306 (e.g., an I²C bus or other suitable communication bus) or other suitable communication channel. In particular, the operating system 108 may include a power manager module 126 or comparable functionally that is operable to direct operation of the charge controller 204 in accordance with a charging policy 212. In order to do so, the operating system 108 may communicate control directives 308 to the charge controller 204 that provides indications regarding charging strategies 210 that are selected and corresponding charging constraints for the cells. The control directives 308 are configured to dynamically program the charge controller 204 to implement different charging strategies 210 at different times in accordance with policy decisions made by the operating system 108, via the power manager module 126 or otherwise.

Control directives 308 may be configured as any suitable messages, signals, or communications that are effective to convey information regarding policy decisions and selected strategies to set-up the charge controller 204 accordingly. By way of an example and not limitation, the operating system may expose an application programming interface (API) 310 that may be used by the power manager module 126 and/or other applications to interact with and configured the charge controller 204. In one approach, the API 310 may be invoked to communicate control directives 308 that are configured to set registers 207 of a charge controller 204 to implement a selected strategy as discussed previously. In any event, the control directives 308 provide a mechanism to access and manipulate charging functionality provided via the charge controller 204 to implement different strategies and tailor charging to different scenarios.

Example Procedures

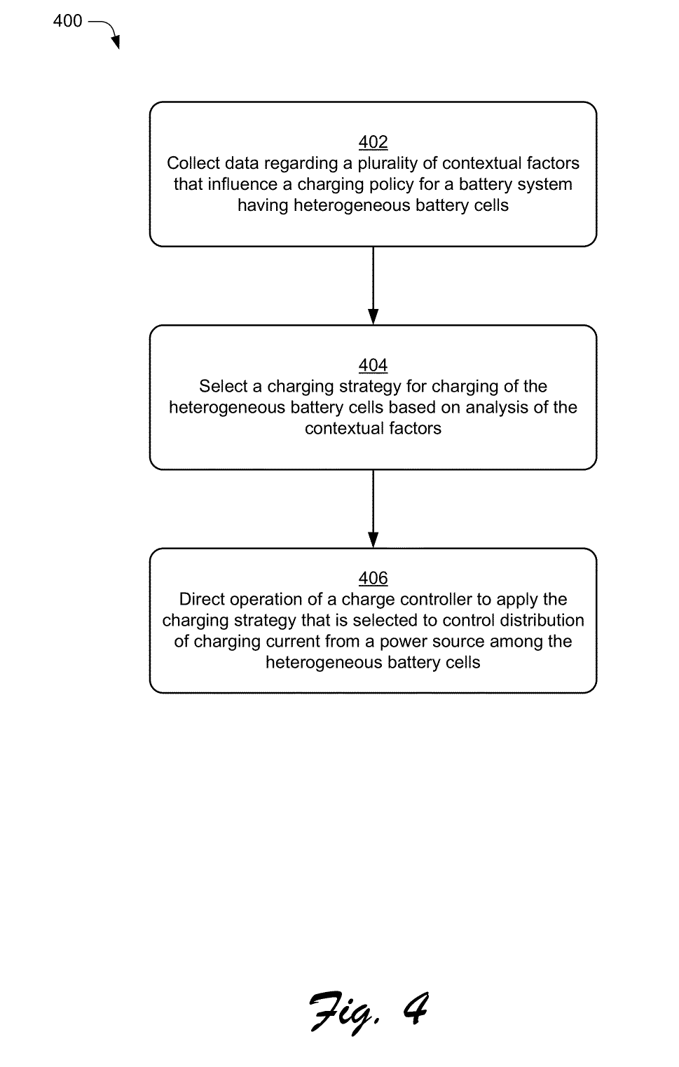

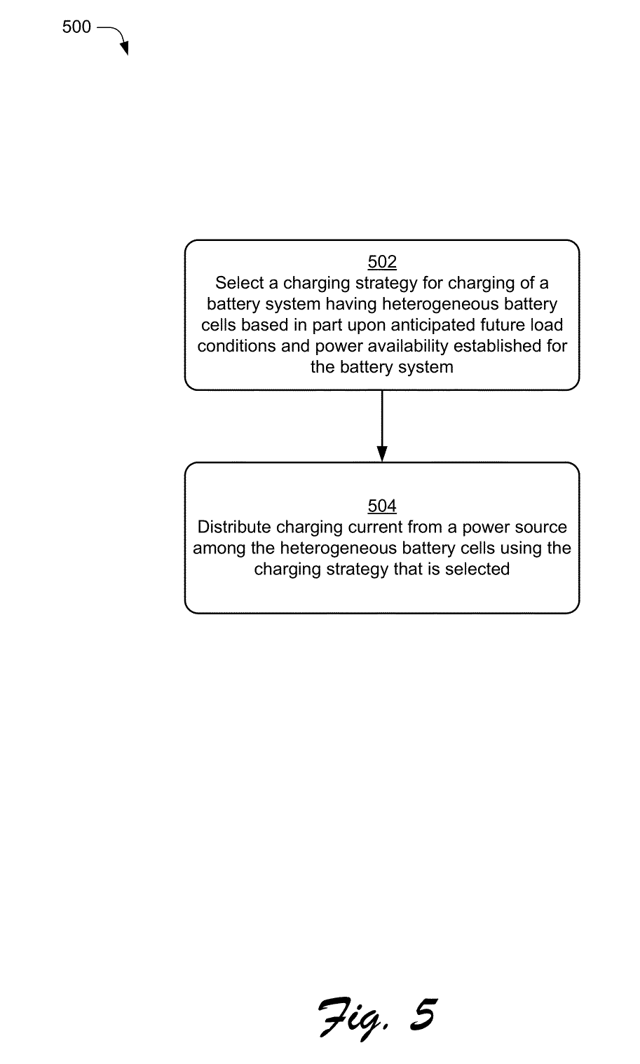

Further aspects of heterogeneous battery cell charging techniques are discussed in relation to example procedure of FIGS. 4 to 5. The procedures described in this document may be implemented utilizing the environment, system, devices, and components described herein and in connection with any suitable hardware, software, firmware, or combination thereof. The procedures may be represented as a set of blocks that specify operations performed by one or more entities and are not necessarily limited to the orders shown for performing the operations by the respective blocks.

FIG. 4 is a flow diagram that describes details of an example procedure 400 for charging of heterogeneous battery cells in accordance with one or more implementations. The procedure 400 can be implemented by way of a suitably configured computing device, such as by way of an operating system 108, power manager module 126, and/or other functionality described in relation to the examples of FIGS. 1-3. Individual operations and details discussed in relation to procedure 400 may also be combined in various ways with operations and details discussed herein in relation to the example procedure of FIG. 5 below.

Data is collected regarding a plurality of contextual factors that influence a charging policy for a battery system having heterogeneous battery cells collected (block 402). For example, various contextual factors 208 may be monitored and analyzed to determine a charging context for a device. Analysis of the contextual factors 208 may occur via a power manager module 126 or comparable functionality implemented via an operating system 108 and/or computing device. It is also contemplated that analysis of contextual factors and other power management functions described herein in relation to power manager module 126 may be implemented via a charge controller 204 (e.g., as a part of charging logic 206). A variety of contextual factors 208 may be relied upon. For instance, the contextual factors may include factors indicative of at least current operating conditions, anticipated future operating conditions, and charging preferences for application and users. Additional factors may relate to characteristics of the power source 302 employed for charging and characteristics of battery cells 202 of the battery system 128 that are being charged.

A charging strategy is selected for charging of the heterogeneous battery cells based on analysis of the contextual factors (block 404). The charging strategy that is selected is configured to match a charging context reflected by the contextual factors 208. In particular, different charging strategies supported by the charge controller 204 are defined to match different combinations of contextual factors. A particular charging context may be recognized based on tracking of the contextual factors and used to select a corresponding charging strategy 210. The charging strategy 210 specifies various charging constraints that are tailored to the recognized charging context, such as cells that are active and inactive for charging, charging rates, portions of available charging current to direct to each cell during charging, order charging, and so forth. In one or more implementation.

Operation of a charge controller is directed to apply the charging strategy that is selected to control distribution of charging current from a power source among the heterogeneous battery cells (block 406). For example, control directives 308 may be communicated to convey information regarding policy decisions and selected strategies to set-up the charge controller 204. The charge controller 204 may then selectively activate and deactivate cells for charging as specified by the charging strategy. The charging strategy specifies constraints for charging of cells on a per-cell basis and may be configured to designate different charge rates, charge levels, charge times and/or charging current for different cells. In some scenarios, the charging strategy causes the charge controller to implement an exchange mode in which charge is migrated between one or more cells as specified by the charging strategy. Charge may be migrated for a variety of reasons. For example, different batteries have different current level and efficiency characteristics that can be taken advantage of depending on the scenario. Thus, if a high-power workload the system may transfer charge from a large capacity, low power cell into a cell that is suited to servicing the high-power workload.

FIG. 5 is a flow diagram that describes details of an example procedure 500 for distributing charging current to cells of a battery system in accordance with one or more implementations. The procedure 500 can be implemented by way of a suitably configured computing device, such as by way of a power manager module 126 and/or other functionality described in relation to the examples of FIG. 1-3. Individual operations and details discussed in relation to procedure 500 may also be combined in various ways with operations and details discussed herein in relation to the example procedure of FIG. 4 above.

A charging strategy is selected for charging of a battery system having heterogeneous battery cells based in part upon anticipated future load conditions and power availability established for the battery system (block 502). For instance, selection of a charging strategy may be informed via analysis of contextual factors. In one or more implementations, this may include information gleaned regarding anticipated future operating conditions such as anticipated future load conditions and availability of power for charging. Anticipated future load conditions may be predicted based upon past user activity with the device, location data, daily behavior patterns, application usage statistics, and schedule information. Likewise, the availability of charging opportunities and the duration of those opportunities may also be assessed using such data. Accordingly, the power manager module 126 is able to understand load requirements that are likely to occur over a period of time as well as the likelihood of there being additional chances to charge battery cells. Based on this contextual information, the power manager module 126 may adjust the charging strategy accordingly to adapt to the expected conditions. For example, if ample charging opportunities are expected, then charging in the current time period may be optimized for fast charging and short term operation. On the other hand, when future load conditions are expected to be rather high and there may be limited charging opportunities, charging may be adapted to maximize charge that will be available to service the load in the future. Thus, an appropriate charging strategy may be selected based on consideration of the anticipated future load conditions and availability of power for charging, as well as other contextual factors discussed herein,

Charging current from a power source is distributed among the heterogeneous battery cells using the charging strategy that is selected (block 504). For example, the power manager module 126 may operate to direct distribution circuity 205 of a charge controller 204 to apply a selected strategy in the manner described herein. The charging strategy that is applied may specify an order in which cells of the heterogeneous battery cells are charged by the charging current as well as an amount of the charging current that is supplied each. Other per-cell constraints may also be implemented, as described previously.

Thus, heterogeneous battery cell charging techniques described in this document provide an intelligent control system for charging of a diverse set of heterogeneous battery cells. The control system may include a power manager module implemented as a component of an operating system for the computing and a charge controller including distribution circuitry operable under the influence of the power manager module to distribute the charging current among the heterogeneous battery cells. The charge controller implements charging strategies to control charging on a per cell basis via respective paths used to route power to and from the cells. Charging performed in this manner enables more efficient charging of a plurality of cells on an individual basis which tailors charging to different contexts, increases device performance, and extends battery life.

Having considered the foregoing details and procedures, consider now example system and components associated with one or more implementations of heterogeneous battery cell charging.

Example System

FIG. 6 illustrates an example system 600 that includes an example computing device 602 that is representative of one or more computing systems and/or devices that may implement the various techniques described herein. The computing device 602 may be, for example, a server of a service provider, a device associated with a client (e.g., a client device), an on-chip system, and/or any other suitable computing device or computing system.

The example computing device 602 as illustrated includes a processing system 604, one or more computer-readable media 606, and one or more I/O interfaces 608 that are communicatively coupled, one to another. Although not shown, the computing device 602 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 604 is representative of functionality to perform one or more operations using hardware. Accordingly, the processing system 604 is illustrated as including hardware elements 610 that may be configured as processors, functional blocks, and so forth. This may include implementation in hardware as an application specific integrated circuit or other logic device formed using one or more semiconductors. The hardware elements 610 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 606 is illustrated as including memory/storage 612. The memory/storage 612 represents memory/storage capacity associated with one or more computer-readable media. The memory/storage 612 may include volatile media (such as random access memory (RAM)) and/or nonvolatile media (such as read only memory (ROM), Flash memory, optical disks, magnetic disks, and so forth). The memory/storage 612 may include fixed media (e.g., RAM, ROM, a fixed hard drive, and so on) as well as removable media (e.g., Flash memory, a removable hard drive, an optical disc, and so forth). The computer-readable media 606 may be configured in a variety of other ways as further described below.

Input/output interface(s) 608 are representative of functionality to allow a user to enter commands and information to computing device 602, and also allow information to be presented to the user and/or other components or devices using various input/output devices. Examples of input devices include a keyboard, a cursor control device (e.g., a mouse), a microphone for voice operations, a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 602 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 602. By way of example, and not limitation, computer-readable media may include “computer-readable storage media” and “communication media.”

“Computer-readable storage media” refers to media and/or devices that enable storage of information in contrast to mere signal transmission, carrier waves, or signals per se. Thus, computer-readable storage media does not include signal bearing media, transitory signals, or signals per se. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Communication media” may refer to signal-bearing media that is configured to transmit instructions to the hardware of the computing device 602, such as via a network. Communication media typically may embody computer readable instructions, data structures, program modules, or other data in a modulated data signal, such as carrier waves, data signals, or other transport mechanism. Communication media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 610 and computer-readable media 606 are representative of instructions, modules, programmable device logic and/or fixed device logic implemented in a hardware form that may be employed in some embodiments to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules including the operating system 108, applications 110, power manager module 126, and other program modules may be implemented as one or more instructions and/or logic embodied on some form of computer-readable storage media and/or by one or more hardware elements 610. The computing device 602 may be configured to implement particular instructions and/or functions corresponding to the software and/or hardware modules. Accordingly, implementation of modules as a module that is executable by the computing device 602 as software may be achieved at least partially in hardware, e.g., through use of computer-readable storage media and/or hardware elements 610 of the processing system. The instructions and/or functions may be executable/operable by one or more articles of manufacture (for example, one or more computing devices 602 and/or processing systems 604) to implement techniques, modules, and examples described herein.

As further illustrated in FIG. 6, the example system 600 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 600, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 602 may assume a variety of different configurations, such as for computer 614, mobile 616, and television 618 uses. Each of these configurations includes devices that may have generally different constructs and capabilities, and thus the computing device 602 may be configured according to one or more of the different device classes. For instance, the computing device 602 may be implemented as the computer 614 class of a device that includes a personal computer, desktop computer, a multi-screen computer, laptop computer, netbook, and so on.

The computing device 602 may also be implemented as the mobile 616 class of device that includes mobile devices, such as a mobile phone, portable music player, portable gaming device, a tablet computer, a multi-screen computer, and so on. The computing device 602 may also be implemented as the television 618 class of device that includes devices having or connected to generally larger screens in casual viewing environments. These devices include televisions, set-top boxes, gaming consoles, and so on.

The techniques described herein may be supported by these various configurations of the computing device 602 and are not limited to the specific examples of the techniques described herein. This is illustrated through inclusion of the power manager module 126 and battery system 128 on the computing device 602. The functionality represented by power manager module 126, battery system 128, and other modules/applications may also be implemented all or in part through use of a distributed system, such as over a “cloud” 620 via a platform 622 as described below.

The cloud 620 includes and/or is representative of a platform 622 for resources 624. The platform 622 abstracts underlying functionality of hardware (e.g., servers) and software resources of the cloud 620. The resources 624 may include applications and/or data that can be utilized while computer processing is executed on servers that are remote from the computing device 602. Resources 624 can also include services provided over the Internet and/or through a subscriber network, such as a cellular or Wi-Fi network.

The platform 622 may abstract resources and functions to connect the computing device 602 with other computing devices. The platform 622 may also serve to abstract scaling of resources to provide a corresponding level of scale to encountered demand for the resources 624 that are implemented via the platform 622. Accordingly, in an interconnected device embodiment, implementation of functionality described herein may be distributed throughout the system 600. For example, the functionality may be implemented in part on the computing device 602 as well as via the platform 622 that abstracts the functionality of the cloud 620.

### Example Implementations

Example implementations of heterogeneous battery cell charging described herein include, but are not limited to, one or any combinations of one or more of the following examples:

### Example 1

A computing device comprising: a battery system having heterogeneous battery cells; a control system configured to: select a charging strategy for charging of the heterogeneous battery cells based in part upon anticipated future load conditions and power availability established for the battery system; and distribute charging current from a power source among the heterogeneous battery cells using the charging strategy that is selected.

### Example 2

The computing device in any one or more of the examples in this section, wherein the heterogeneous battery cells include at least two cells having different characteristics including differences in at least one of size, capacity, battery technology, chemistry, shape or state of charge (SOC).

### Example 3

The computing device in any one or more of the examples in this section, wherein the charging strategy indicates an order in which cells of the heterogeneous battery cells are charged by the charging current.

### Example 4

The computing device in any one or more of the examples in this section, wherein the charging strategy indicates an amount of the charging current to provide for charging each of the heterogeneous battery cells.

### Example 5

The computing device in any one or more of the examples in this section, wherein selection of the charging strategy is based upon an assessment of a plurality of contextual factors that influence a charging policy for the battery system.

### Example 6

The computing device in any one or more of the examples in this section, wherein selection of the charging strategy is further based upon contextual factors including one or more of: an amount of charging current available, time available for charging, charge states of the heterogeneous battery cells, battery cell charging current requirements, battery cell charging current capabilities, battery cell charging rates, battery cell temperatures, or battery aging constraints.

### Example 7

The computing device in any one or more of the examples in this section, wherein the control system includes a power manager module implemented as a component of an operating system for the computing and a charge controller including distribution circuitry operable under the influence of the power manager module to distribute the charging current among the heterogeneous battery cells.

### Example 8

The computing device in any one or more of the examples in this section, wherein the control system is further configured to communicate control directives to direct operation of the distribution circuitry to cause distribution of the charging current to the heterogeneous battery cells using the charging strategy that is selected.

### Example 9

The computing device in any one or more of the examples in this section, wherein the control directives are configured to set registers implemented by the charge controller to specify parameters that are employed by charging logic of the charge controller to distribute the charging current according to the charging strategy that is selected.

### Example 10

The computing device in any one or more of the examples in this section, wherein the anticipated future load conditions are predicted based on information gathered regarding past user activity with the computing device, location data, daily behavior patterns, application usage statistics, and schedule information.

### Example 11

A method implemented by a computing device comprising: collecting data regarding a plurality of contextual factors that influence a charging policy for a battery system of the computing device having heterogeneous battery cells; selecting a charging strategy for charging of the heterogeneous battery cells based on analysis of the contextual factors; and directing operation of a charge controller to apply the charging strategy that is selected to control distribution of charging current from a power source among the heterogeneous battery cells.

### Example 12

The method in any one or more of the examples in this section, wherein directing operation of a charge controller to apply the charging strategy causes the charge controller to selectively activate and deactivate cells for charging as specified by the charging strategy.

### Example 13

The method in any one or more of the examples in this section, wherein the charging strategy is configured to designate different charge rates for different cells.

### Example 14

The method in any one or more of the examples in this section, further comprising recognizing a charging context reflected by the contextual factors based on the analysis of the contextual factors, wherein: different charging strategies supported by the charge controller are defined to match different combinations of contextual factors; the contextual factors include factors indicative of at least current operating conditions, anticipated future operating conditions, and charging preferences for application and users; and selecting of the charging strategy occurs responsive to recognizing the charging context such that the charging strategy that is selected matches the charging context.

### Example 15

The method in any one or more of the examples in this section, wherein directing operation of a charge controller to apply the charging strategy causes the charge controller to implement an exchange mode in which charge is migrated between cells as specified by the charging strategy.

### Example 16

A charge controller for charging of a battery system having heterogeneous battery cells on a per-cell basis comprising: distribution circuitry to interconnect the heterogeneous battery cells and route charging current from a power source to heterogeneous battery cells, the distribution circuitry connecting each of the heterogeneous battery cells directly to the charge controller to provide individual current paths to and from each of the heterogeneous battery cells; charging logic to control the distribution circuitry to distribute charging current to the heterogeneous battery cells and migrate charge between cells of the heterogeneous battery cells in accordance with a charging strategy established for the battery system; and registers configurable to specify parameters that are employed by control logic to implement the charging strategy established for the battery system

### Example 17

A charge controller as recited in any one or more of the examples in this section, wherein the registers are accessible via an application programming interface (API) exposed by an operating system of a device in which the charge controller is utilized to dynamically program the charge controller to implement different charging strategies by setting the parameters to corresponding values.

### Example 18

A charge controller as recited in any one or more of the examples in this section, wherein the registers include registers associated with each battery cell to specify charging constraints on a per-cell basis that specify one or more of: cells that are active and inactive for charging, portions of charging current to direct to each cell during charging, priority of cells to control charging order of the cells, or levels of charge to attain for each cell during charging.

### Example 19

A charge controller as recited in any one or more of the examples in this section, wherein the charging strategy is established at runtime based on a combination of contextual factors including at least current operating conditions and anticipated future operating conditions.

### Example 20

A charge controller as recited in any one or more of the examples in this section, wherein the distribution circuitry includes switching mechanisms to route the charging current via the individual current paths.

### CONCLUSION

Although techniques and aspects have been described in language specific to structural features and/or methodological acts, it is to be understood that the subject matter defined in the appended claims are not necessarily limited to the specific features or acts described. Rather, the specific features and acts are disclosed as example forms of implementing the claimed subject matter.

What is claimed is:

1. A computing device comprising:
a battery system having heterogeneous battery cells;
a control system configured to:
select a charging strategy for charging of the heterogeneous battery cells based in part upon anticipated future load conditions and power availability established for the battery system; and
distribute charging current from a power source among the heterogeneous battery cells using the charging strategy that is selected.

2. The computing device of claim 1, wherein the heterogeneous battery cells include at least two cells having different characteristics including differences in at least one of size, capacity, battery technology, chemistry, shape or state of charge (SOC).

3. The computing device of claim 1, wherein the charging strategy indicates an order in which cells of the heterogeneous battery cells are charged by the charging current.

4. The computing device of claim 1, wherein the charging strategy indicates an amount of the charging current to provide for charging each of the heterogeneous battery cells.

5. The computing device of claim 1, wherein selection of the charging strategy is based upon an assessment of a plurality of contextual factors that influence a charging policy for the battery system.

6. The computing device of claim 1, wherein selection of the charging strategy is further based upon contextual factors including one or more of: an amount of charging current available, time available for charging, charge states of the heterogeneous battery cells, battery cell charging current requirements, battery cell charging current capabilities, battery cell charging rates, battery cell temperatures, or battery aging constraints.

7. The computing device of claim 1, wherein the control system includes a power manager module implemented as a component of an operating system for the computing and a charge controller including distribution circuitry operable under the influence of the power manager module to distribute the charging current among the heterogeneous battery cells.

8. The computing device of claim 7, wherein the control system is further configured to communicate control directives to direct operation of the distribution circuitry to cause distribution of the charging current to the heterogeneous battery cells using the charging strategy that is selected.

9. The computing device of claim 8, wherein the control directives are configured to set registers implemented by the charge controller to specify parameters that are employed by charging logic of the charge controller to distribute the charging current according to the charging strategy that is selected.

10. The computing device of claim 1, wherein the anticipated future load conditions are predicted based on information gathered regarding past user activity with the computing device, location data, daily behavior patterns, application usage statistics, and schedule information.

11. A method implemented by a computing device comprising:
collecting data regarding a plurality of contextual factors that influence a charging policy for a battery system of the computing device having heterogeneous battery cells;
selecting a charging strategy for charging of the heterogeneous battery cells based on analysis of the contextual factors; and
directing operation of a charge controller to apply the charging strategy that is selected to control distribution of charging current from a power source among the heterogeneous battery cells.

12. The method of claim 11, wherein directing operation of the charge controller to apply the charging strategy causes the charge controller to selectively activate and deactivate cells for charging as specified by the charging strategy.

13. The method of claim 11, wherein the charging strategy is configured to designate different charge rates for different cells.

14. The method of claim 11, further comprising recognizing a charging context reflected by the contextual factors based on the analysis of the contextual factors, wherein:
different charging strategies supported by the charge controller are defined to match different combinations of contextual factors;
the contextual factors include factors indicative of at least current operating conditions, anticipated future operating conditions, and charging preferences for application and users; and
selecting of the charging strategy occurs responsive to recognizing the charging context such that the charging strategy that is selected matches the charging context.

15. The method of claim 11, wherein directing operation of the charge controller to apply the charging strategy causes the charge controller to implement an exchange mode in which charge is migrated between cells as specified by the charging strategy.

16. A charge controller for charging of a battery system having heterogeneous battery cells on a per-cell basis comprising:
distribution circuitry to interconnect the heterogeneous battery cells and route charging current from a power source to heterogeneous battery cells, the distribution circuitry connecting each of the heterogeneous battery cells directly to the charge controller to provide individual current paths to and from each of the heterogeneous battery cells;
charging logic to control the distribution circuitry to distribute charging current to the heterogeneous battery cells and migrate charge between cells of the heterogeneous battery cells in accordance with a charging strategy established for the battery system; and
registers configurable to specify parameters that are employed by control logic to implement the charging strategy established for the battery system.

17. A charge controller as recited in claim 16, wherein the registers are accessible via an application programming interface (API) exposed by an operating system of a device in which the charge controller is utilized to dynamically program the charge controller to implement different charging strategies by setting the parameters to corresponding values.

18. A charge controller as recited in claim 16, wherein the registers include registers associated with each battery cell to specify charging constraints on a per-cell basis that specify one or more of: cells that are active and inactive for charging, portions of charging current to direct to each cell during charging, priority of cells to control charging order of the cells, or levels of charge to attain for each cell during charging.

19. A charge controller as recited in claim 16, wherein the charging strategy is established at runtime based on a combination of contextual factors including at least current operating conditions and anticipated future operating conditions.

20. A charge controller as recited in claim 16, wherein the distribution circuitry includes switching mechanisms to route the charging current via the individual current paths.
